(19) United States
(12) Patent Application Publication
(10) Pub. No.: US 2022/0325073 A1
(43) Pub. Date: Oct. 13, 2022

(54) MATRIX RESIN FOR LAMINATES WITH HIGH TRANSPARENCY, LOW YELLOWING AND HIGH GLASS TRANSITION TEMPERATURES

(71) Applicant: Henkel AG & Co. KGaA, Duesseldorf (DE)

(72) Inventors: Konstantinos Markou, Koeln (DE); Mustapha Benomar, Duisburg (DE); Ligang Zhao, Duesseldorf (DE); Hans-Georg Kinzelmann, Pulheim (DE)

(21) Appl. No.: 17/750,676

(22) Filed: May 23, 2022

Related U.S. Application Data
(63) Continuation of application No. PCT/EP2020/082628, filed on Nov. 19, 2020.

(30) Foreign Application Priority Data
Nov. 22, 2019 (EP) 19211023.7

(51) Int. Cl. C08K 5/50; B29C 67/24; B29C 70/48

(52) U.S. Cl. CPC C08K 5/50; B29C 67/246; B29C 70/48; B29K 2063/00

(57) ABSTRACT

The present invention relates to curable resin compositions, to methods for producing cured compositions using said curable resin compositions, and to items, in particular molded parts, produced by means of such method.

The present invention relates to curable resin compositions, to methods for producing cured compositions using said curable resin compositions, and to items, in particular molded parts, produced by means of such methods.

The lightweight construction of automobiles is becoming increasingly important in the automotive industry, with molded parts made of carbon fiber-reinforced plastics material (CFRP) in particular being in increasing demand from the automotive industry. Such molded parts are installed, for example, in the form of rims which are exposed to high temperatures during braking processes. Consequently, it is essential to use matrix resins which have very high glass transition temperatures T_{g} in the cured state when producing the corresponding molded parts, since otherwise a heat-repellent protective lacquer would have to be applied, which would make the production process even more complex. For this reason, matrix resins based on epoxy-anhydride systems are preferably used, since these have high glass transition temperatures when appropriately crosslinked. Tertiary amines are usually used as curing-accelerating catalysts in such systems. After being completely cured, however, corresponding items and molded parts show a clear tendency to yellow and only have moderate transparency. In particular in the case of visible components such as car rims, however, an attractive appearance is still desirable. Customers want visible components with what is referred to as carbon fiber look, in which the incorporated carbon fibers should be clearly visible. There is consequently a need for resin compositions which produce cured items with high glass transition temperatures and are as transparent as possible and have little yellowing.

The present invention is based on the discovery by the inventors that by using quaternary phosphonium compounds instead of tertiary amines as curing catalysts in epoxy resin-anhydride systems, curable formulations can be obtained which, in the cured state, have both high glass transition temperatures and excellent optical properties, i.e., reduced yellowing and improved transparency.

The plastic materials obtainable in this way thus demonstrate advantageous mechanical and optical properties and are therefore particularly suitable for use in automobile construction, in particular in the form of fiber-reinforced plastics molded parts.

In a first aspect, the present invention therefore relates to a resin composition comprising at least one epoxy resin component and at least one curing component, characterized in that the resin composition further comprises at least one quaternary phosphonium compound.

A further aspect of the present invention provides a method for producing a cured composition comprising the steps of:

(1) providing a resin composition as described herein; and
(2) curing the resin composition in order to obtain a cured composition.

In a further aspect, the present invention relates to a cured composition obtainable according to a method as described herein.

“At least one,” as used herein, refers to 1 or more, for example 1, 2, 3, 4, 5, 6, 7, 8, 9 or more. In connection with constituents of the catalyst compositions described herein, this statement refers not to the absolute quantity of molecules, but rather to the type of constituent. “At least one epoxy” therefore signifies, for example, one or more different epoxies, i.e., one or more different types of epoxies. Together with stated amounts, the stated amounts refer to the total amount of the correspondingly designated type of constituent, as defined above.

“About” or “approximately,” as used herein in connection with numerical values, refers to the referenced numerical value ±10%, preferably ±5%.

The viscosity of the liquid composition described herein is in particular low enough for the composition to be pumpable and to be able to wet and impregnate fiber materials, for example, as used for fiber-reinforced plastics parts. In various embodiments, the reaction mixture has a viscosity of <100 mPas at a temperature of 100° C. To determine the viscosity, the resin mixture is prepared at room temperature using a suitable mixer and the viscosity is determined in rotation on a plate/plate rheometer with a diameter of 25 mm, a gap of 0.05 mm and a shear rate of 100 s as the temperature increases at a heating rate of 6 K/min.

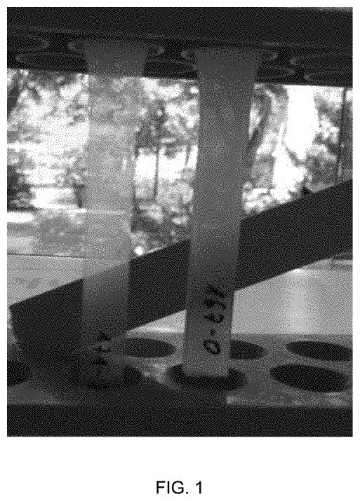

FIG. 1 shows two cured polymer strips. The right strip was obtained by curing a conventional epoxy-anhydride-based resin composition to which 1-methylimidazole was added as a curing catalyst. The left strip was obtained by curing a resin composition according to the present invention to which an ionic liquid containing a quaternary phosphonium compound (trihexyl(tetradecyl)phosphonium chloride) was added as a curing catalyst instead of a tertiary amine compound. After pre-curing at 120° C. for 20 minutes, the two polymers were post-cured for one hour at 180° C. and then for a further hour at 220° C. FIG. 1 clearly shows that the polymer strip on the left is significantly more transparent and less yellowed than the polymer strip on the right. In addition, it was found that the E′ onset T_{g} in the DMTA measurement had increased by 10-15° C.

The present invention relates to resin compositions which comprise at least one epoxy resin component and at least one curing component and are further characterized in that they further comprise at least one quaternary phosphonium compound.

Suitable phosphonium compounds are shown in the context of the present invention by the following formula:

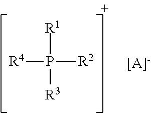

where each R¹-R⁴ is selected, independently from one another, from hydrogen, halogen, linear or branched C1-C20 alkyl, linear or branched C2-C20 alkenyl, linear or branched C2-C20 alkynyl, C3-C8 cycloalkyl, and C6-C10 aryl, it being possible for the aforementioned organic functional groups to each be substituted or unsubstituted, the substituents each being independently selected from C1-C6 alkyl, C2-C6 alkenyl, C2-C6 alkynyl and halogen; and A represents a halogen atom. The functional groups R¹-R⁴ are preferably each selected, independently from one another, from linear C1-C12 alkylenes such as methyl, ethyl, n-propyl, n-butyl, n-pentyl, n-hexyl, n-heptyl, n-octyl, n-nonyl, n-decyl, n-undecyl and n-dodecyl.

In some embodiments, the counterion [A]⁻ in the above formula can also be a quaternary boron compound such as tetraphenylborate, an alkyl phosphate, an alkyl phosphinate, trifluoromethylsulfonylamide, dicyanamide, an alkanoate and a tosylate.

In some embodiments, the at least one phosphonium compound is trihexyl(tetradecyl)phosphonium chloride and/or tributylethylphosphonium diethyl phosphate.

According to some embodiments, suitable phosphonium compounds can also be in the form of ionic liquids.

The resin compositions according to the invention contain the at least one quaternary phosphonium compound preferably in an amount in the range of from 0.1 to 5 wt. %, preferably in an amount in the range of from 0.4 to 1.5 wt. %, based in each case on the total weight of the resin composition.

In preferred embodiments, the at least one quaternary phosphonium compound is present as part of the curing component in the resin compositions according to the invention.

According to the invention, the resin compositions also comprise at least one epoxy resin component. A suitable epoxy resin component comprises one or more epoxy compounds, as described below.

In the context of the present invention, an epoxy resin may comprise epoxide group-containing monomers, prepolymers and polymers as well as mixtures thereof, and is also referred to in the following as epoxide or epoxide group-containing resin. Suitable epoxide group-containing resins are in particular resins having 1 to 10, preferably 2 to 10, epoxide groups per molecule. “Epoxide groups,” as used herein, refers to 1,2-epoxide groups (oxiranes).

The epoxy resins which can be used herein may vary and include conventional and commercially available epoxy resins, each of which may be used individually or in a combination of two or more different epoxy resins. When selecting the epoxy resins, not only are the properties of the final product important but also the properties of the epoxy resin such as the viscosity and other properties which affect processability.

The epoxide equivalent of the polyepoxides can vary between 75 and 50,000, preferably between 170 and 5,000. In principle, the polyepoxides may be saturated, unsaturated, cyclic or acyclic, aliphatic, cycloaliphatic, aromatic or heterocyclic polyepoxide compounds.

According to some embodiments, the at least one epoxy resin component comprises a cycloaliphatic epoxy resin.

Examples of suitable cycloaliphatic epoxides are compounds which have a saturated hydrocarbon ring having an epoxide oxygen atom bonded to two adjacent carbon atoms of the carbon ring, as shown in the following formula:

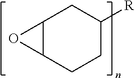

where R is a linking group and n is an integer from 2 to 10, preferably from 2 to 4, and even more preferably from 2 to 3. These are diepoxides or polyepoxides if n is 2 or more. Such cycloaliphatic epoxy resins can have an epoxy equivalent weight of from approximately 95 to 250, in particular from 100 to 150. Mixtures of monoepoxides, diepoxides and/or polyepoxides can be used.

Further examples of suitable cycloaliphatic epoxides are in particular the epoxides of cycloaliphatic esters of dicarboxylic acids such as bis-(3,4-epoxycyclohexylmethyl) oxalate, bis-(3,4-epoxy-cyclohexylmethyl) adipate, bis-(3,4-epoxy-6-methylcyclohexylmethyl) adipate, bis-(3,4-epoxycyclohexylmethyl) pimelate. Further suitable diepoxides of cycloaliphatic esters are described, for example, in U.S. Pat. No. 2,750,395.

Further suitable cycloaliphatic epoxides are, for example, 3,4-epoxycyclohexylmethyl-3,4-epoxycyclohexane carboxylate, bis-(3,4-epoxycyclohexyl) adipate, and 3,4-epoxy-1-methylcyclohexylmethyl-3,4-epoxy-1-methylcyclohexane carboxylate. Further suitable cycloaliphatic epoxides are described, for example, in US-A-2890194.

According to some embodiments, the at least one epoxy resin component comprises an epoxy compound selected from the group consisting of bis-(3,4-epoxycyclohexylmethyl) oxalate, bis-(3,4-epoxycyclohexylmethyl) adipate, bis-(3,4-epoxy-6-methylcyclohexylmethyl) adipate, bis-(3,4-epoxycyclohexylmethyl) pimelate, 3,4-epoxycyclohexylmethyl-3,4-epoxycyclohexane carboxylate, bis-(3,4-epoxycyclohexyl) adipate, 3,4-epoxy-1-methylcyclohexylmethyl-3,4-epoxy-1-methylcyclohexane carboxylate, and mixtures thereof.

Further examples of polyepoxides which are suitable for use in the resin compositions according to the invention include, for example, polyglycidyl ethers prepared by reacting epichlorohydrin or epibromohydrin with a polyphenol in the presence of an alkali. Polyphenols suitable for this are, for example, resorcinol, pyrocatechol, hydroquinone, bisphenol A (bis-(4-hydroxy-phenyl)-2,2-propane), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane and 1,5-hydroxynaphthaline. Other polyphenols that are suitable as the basis for polyglycidyl ethers are the known condensation products of phenol and formaldehyde or acetaldehyde of the novolac resin type.

Other polyepoxides that are in principle suitable are the polyglycidyl ethers of polyalcohols or diamines. These polyglycidyl ethers are derived from polyalcohols such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides are polyglycidyl esters of polycarboxylic acids, for example reaction products of glycidol or epichlorohydrin with aliphatic or aromatic polycarboxylic acids such as oxalic acid, succinic acid, glutaric acid, terephthalic acid or dimer fatty acid.

Other suitable epoxy resins are known in the prior art and can be found, for example, in Lee H. & Neville, K., Handbook of Epoxy Resins, McGraw-Hill Book Company, 1982 reprint.

Other epoxides are derived from the epoxidation products of olefinically unsaturated cycloaliphatic compounds or from native oils and fats.

Depending on the intended use, it can be preferable for the composition to additionally contain a flexibilizing resin. This may also be an epoxy resin. The inherently known adducts of carboxyl-terminated butadiene-acrylonitrile copolymers (CTBN) and liquid epoxy resins based on the diglycidyl ether of bisphenol A can be used as flexibilizing epoxy resins. Specific examples are the reaction products of Hycar CTBN 1300×8, 1300×13 or 1300×15 from B. F. Goodrich with liquid epoxy resins. Furthermore, the reaction products of amino-terminated polyalkylene glycols (jeffamine) can also be used with an excess of liquid polyepoxides. In principle, reaction products of mercapto-functional prepolymers or liquid Thiokol polymers can also be used according to the invention with an excess of polyepoxides as flexibilizing epoxy resins. However, the reaction products of polymeric fatty acids, in particular dimer fatty acid, with epichlorohydrin, glycidol or in particular diglycidyl ether of bisphenol A (DGBA) are very particularly preferred.

The resin compositions according to the invention further comprise at least one curing component.

According to some embodiments, the at least one curing component comprises at least one anhydride curing agent.

Examples of suitable anhydride-based curing agents are norbornene-based dicarboxylic acid anhydrides. Suitable norbornene-based dicarboxylic acid anhydrides are shown by the following formula:

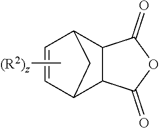

where each R independently represents hydrocarbyl, halogen or inertly substituted hydrocarbyl; z is an integer from 0 to 8, preferably an integer from 0 to 2, in particular from 0 to 1; and R², if present, represents an alkyl group, preferably a methyl group. As used herein, the term “inertly substituted” means that the substituent does not adversely affect the ability of the anhydride group to react with and cure the epoxy resin. In cases where z is 1 or more, preferably at least one R² group is bonded to the carbon atom in position 5. In norbornene-based dicarboxylic acid anhydrides, the dicarboxylic acid anhydride group can be in the exo or endo conformation. In the context of this invention, the two isomers and mixtures of the two isomers are suitable in principle. Preferred examples of a norbornene-based dicarboxylic acid anhydride as described herein are bicyclo[2.2.1]-5-heptene-2,3-dicarboxylic acid anhydride, i.e., an anhydride of the aforementioned structure, where z is 0, and bicyclo[2.2.1]methylhept-5-ene-2,3-dicarboxylic acid anhydride, i.e., an anhydride of the aforementioned structure, where R² is methyl and z is 1, the methyl group preferably being bonded to the carbon atom in position 5. According to some embodiments, the at least one curing component of the resin compositions described herein comprises at least one anhydride curing agent, the at least one anhydride curing agent being selected from bicyclo[2.2.1]-5-heptene-2,3-dicarboxylic acid anhydride, bicyclo[2.2.1]-methylhept-5-ene-2,3-dicarboxylic anhydride, and mixtures thereof. Other suitable anhydride-based curing agents are saturated norbornene-based dicarboxylic acid anhydrides. These are derived from the structures mentioned above, the double bond in the norbornene skeleton being hydrogenated.

Further anhydride curing agents are aliphatic anhydrides such as hexahydrophthalic anhydride, tetrahydrophthalic anhydride, methyltetrahydrophthalic anhydride, methythexahydrophthalic anhydride, and mixtures thereof, as well as aromatic anhydrides such as phthalic anhydride, trimellitic anhydride, and mixtures thereof. Particularly suitable anhydride curing agents are hexahydrophthalic anhydride, methylhexahydrophthalic anhydride, and mixtures thereof. Further suitable anhydride curing agents are copolymers of styrene and maleic anhydride as well as other anhydrides which are copolymerizable with styrene.

According to preferred embodiments, the at least one curing component of the resin compositions described herein comprises at least one anhydride curing agent, the at least one anhydride curing agent being selected from hexahydrophthalic anhydride, methylnexahydrophthalic anhydride, and mixtures thereof.

Guanidines, substituted guanidines, substituted ureas, melamine resins, guanamine derivatives, cyclic tertiary amines, aromatic amines, and/or mixtures thereof can also be used as thermally activatable or latent curing agents. In this case, the curing agents can be stoichiometrically involved in the curing reaction. However, they may also have a catalytic effect. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and more particularly cyanoguanidine (dicyandiamide). Representatives of suitable guanamine derivatives which may be mentioned are alkylated benzoguanamine resins, benzoguanamine resins or methoxymethyl-ethoxymethyl benzoguanamine. For monocomponent, heat-curing shaped bodies, the selection criterion is the low solubility of these substances at room temperature in the resin system, such that solid, finely ground curing agents are preferred in this case. Dicyandiamide is particularly suitable. Good storage stability of the heat-curable shaped bodies is thereby ensured.

In addition to or instead of the aforementioned curing agents, substituted ureas that have a catalytic effect can be used. These are in particular p-chlorophenyl-N,N-dimethylurea (monuron), 3-phenyl-1,1-dimethylurea (fenuron) or 3,4-dichlorophenyl-N,N-dimethylurea (diuron). In principle, it is also possible to use tertiary acrylic or alkyl amines that have a catalytic effect, for example benzyldimethylamine, tris(dimethylamino)phenol, piperidine or piperidine derivatives. However, these often have too high a solubility in the adhesive system, such that the monocomponent system is not suitably storage stable. Furthermore, various, preferably solid imidazole derivatives can be used as accelerators that have a catalytic effect. Representative examples include 2-ethyl-2-methylimidazole, N-butylimidazole, benzimidazole and N—C₁₋₁₂-alkylimidazoles or N-arylimidazoles. Particularly preferred is the use of a combination of a curing agent and an accelerator in the form of what is referred to as accelerated dicyandiamides in a finely ground form. This means that it is superfluous to separately add accelerators that have a catalytic effect to the epoxide curing system.

The compositions according to the invention can also be formulated as two-component compositions in which the two reaction components are only mixed with one another shortly before application, curing then taking place at room temperature or at a moderately elevated temperature. The reaction components known per se for two-component epoxy compositions can be used as the second reaction component, for example di- or polyamines, amino-terminated polyalkylene glycols (e.g., jeffamines or amino-poly-THF) or polyaminoamides. Further reactive partners can be mercapto-functional prepolymers such as the liquid Thiokol polymers, and the epoxy compositions according to the invention can also preferably be cured in 2K formulations with carboxylic acid anhydrides as the second reaction component.

According to some embodiments, however, the resin compositions described herein are free from tertiary amine compounds.

The amount of curing agent depends on a number of factors, but concentrations in the range of from 0.5 to 60 wt. %, based on the total weight of the formulation, are common. In the case of an anhydride-based curing agent, the amount of anhydride to the epoxide is preferably selected in a molar ratio of from 2:1 to 1:2, preferably 1.1:1 to 1:1.1, particularly preferably equimolar.

The present invention also relates to a method for producing a cured composition comprising the steps of: (1) providing a resin composition as described above; and (2) curing the resin composition in order to thereby obtain a cured composition.

Correspondingly cured compositions have an increased mechanical stability, in particular an increased impact toughness, without lowering the glass transition temperature, and therefore the compositions obtained can be exposed to elevated temperatures during manufacture and their intended use. Said polyols are therefore particularly suitable for the production of fiber-reinforced plastics shaped parts such as automobile parts.

“Providing,” as used herein, refers to mixing the constituents of the resin composition in any sequence. It can be advantageous, for example, first to combine two or more constituents and optionally mix them to form a heterogeneous or homogeneous mixture before the remaining constituents are added. For example, the at least one epoxy resin component can first be mixed with optionally other constituents and then, for example shortly before curing, the at least one curing component can be added and mixed into the other constituents which have already been mixed through. It can be advantageous to cool the reaction mixture to room temperature between the various combining and mixing steps. In another embodiment, it can be advantageous to heat the reaction mixture in order to improve the solubility between the various combining and mixing steps.

In general, the individual constituents of the resin composition can be used per se or as a solution in a solvent, for example an organic solvent or a mixture of organic solvents. For this purpose, every known solvent that is suitable for the purpose according to the invention can be used. The solvent can be a high-boiling organic solvent, for example. The solvent can be selected from the group consisting of petroleum, benzene, toluene, xylene, ethyl benzene, and mixtures thereof.

The resin composition described herein can be combined with other constituents known from the prior art in the form of an adhesive composition or an injection resin.

Adhesive compositions or injection resins of this kind can contain many other components, all of which are known to a person skilled in the art, including, but not limited to, frequently used auxiliaries and additives, for example fillers, plasticizers, reactive and/or nonreactive diluents, mobile solvents, coupling agents (e.g., silanes), release agents, adhesion promoters, wetting agents, adhesion agents, flame retardants, wetting agents, thixotropic agents and/or rheological auxiliaries (e.g., pyrogenic silicic acid), aging and/or corrosion inhibitors, stabilizers and/or dyes. Depending on the requirements of the adhesive or the injection resin and the application thereof and with respect to the production, flexibility, strength and adhesion to substrates, the auxiliaries and additives are worked into the composition in different amounts.

For example, in some embodiments, resin compositions according to the invention comprise organic particles having a core-shell structure. The organic particles having a core-shell structure are preferably rubber particles. The rubber particles having a core-shell structure can all be particulate materials having a rubber core which are known and suitable for the purpose described herein. Preferred core-shell-particle compositions are. The rubber core preferably has a glass transition temperature T_{g} of below −25° C., more preferably of less than −50° C., and even more preferably of less than −70° C. The T_{g} of the core can even be well below −100° C. The core-shell particles also have a shell portion which preferably has a T_{g} of at least 50° C.

The “core” here means the inner part of the particle. The core can represent the center of the core-shell particle or an inner sheath or domain of the particle. “Sheath” or “shell” here means the part outside the core which usually forms the outer sheath, i.e., the outermost part of the particle. The shell material is preferably grafted onto or cross-linked to the core. The rubber core can make up 50 to 95 wt. %, in particular 60 to 90 wt. %, of the particle.

The core of the particle can be a polymer or copolymer of a conjugated diene such as butadiene, or a lower alkyl acrylate such as n-butyl, ethyl, isobutyl or 2-ethylhexyl acrylate. The core polymer can additionally contain up to 20 wt. % of further copolymerized monounsaturated monomers such as styrene, vinyl acetate, vinyl chloride, methyl methacrylate and the like. The core polymer is optionally cross-linked. In certain embodiments, it contains up to 5 wt. % of a copolymerized graft monomer which contains two or more unsaturated bonds with different reactivity such as diallyl maleate, monoallyl fumarate, allyl methacrylate and the like, with at least one of the unsaturated bonds not being conjugated.

The core polymer can also be a silicone rubber. These materials often have glass transition temperatures below −100° C. Core-shell particles which have such silicone rubber cores include those that are commercially available from Wacker Chemie (Munich, Germany) under the trade name Genioperl.

The shell polymer which is optionally grafted onto or cross-linked with the core is preferably a polymer of a lower alkyl methacrylate such as methyl methacrylate, ethyl methacrylate or t-butyl methacrylate. Homopolymers of such methacrylates can be used. Furthermore, up to 40 wt. % of the shell polymer can be formed from other vinyl monomers such as styrene, vinyl acetates, vinyl chloride, methyl acrylate, ethyl acrylate, butyl acrylate and the like. The molecular weight of the grafted shell polymer is generally between 20,000 and 500,000.

The rubber particles usually have average particle sizes of from approximately 0.03 to approximately 2 micrometers or from approximately 0.05 to approximately 1 micrometer. In certain embodiments of the invention, the rubber particles have an average diameter of less than approximately 500 nm. In other embodiments, the average particle size is less than approximately 200 nm. For example, the core-shell rubber particles can have an average diameter in the range of from approximately 25 to approximately 200 nm or from approximately 50 to 150 nm.

The core-shell particles can have reactive groups in the shell polymer that can react with an epoxy resin or an epoxy resin curing agent. For example, glycidyl groups are suitable. Particularly preferred core-shell particles are those which are described in European patent application EP 1 632 533 A1. The core-shell particles described therein include a cross-linked rubber core, in most cases a cross-linked copolymer of butadiene, and a shell which is preferably a copolymer of styrene, methyl methacrylate, glycidyl methacrylate and optionally acrylonitrile.

In various embodiments, core-shell particles are used, as they are described in WO 2007/025007.

The rubber particles having a core-shell structure are preferably dispersed in a polymer or epoxy resin, as also described in the document cited above. Preferred core-shell particles include those available from Kaneka Corporation under the name Kaneka Kane Ace, including Kaneka Kane Ace 15 and the 120 product line, including Kaneka Kane Ace MX 153, Kaneka Kane Ace MX 156, Kaneka Kane Ace MX 257 and Kaneka Kane Ace MX 120 core-shell particle dispersions and mixtures thereof. These products contain the core-shell rubber particles predispersed in an epoxy resin at concentrations of approximately 33 or 25%.

The resin compositions according to the invention can contain the core-shell particles in total amounts of from 1 wt. % to 30 wt. %, in particular 15 to 25 wt. %, based in each case on the total weight of the resin composition and the core-shell particles per se, i.e., without any dispersion medium that may be present.

Suitable fillers include the various chalks, quartz powder, alumina, dolomite, carbon fibers, glass fibers, polymer fibers, titanium dioxide, silica glass, activated carbon, talc, calcium oxide, calcium magnesium carbonates, barium sulfate, and in particular silicate-like fillers of the aluminum-magnesium-calcium silicate type such as wollastonite and chlorite. Typically, the compositions contain from approximately 0.5 to approximately 10 wt. % fillers.

In preferred embodiments, the compositions of the invention do not contain plasticizers, or contain less than 0.1 wt. % plasticizers, since these tend to lower the T_{g}.

In various embodiments of the invention, depending on the desired use, the resin composition is applied to a substrate, for example when being used as an adhesive, or filled into a die or when being used as a molding material for producing plastics parts. In preferred embodiments, the method is a transfer molding (RTM) method and the resin composition is a reactive injection resin. “Reactive,” as used in this context, refers to the fact that the injection resin is chemically crosslinkable. In the RTM method, providing the resin composition, i.e., step (1) of the described method, can comprise filling, in particular injecting, the injection resin into a die. In the production of fiber-reinforced plastics parts for which the described method and reaction mixtures are particularly suitable, fibers or semi-finished fiber products (prewovens/preforms) can be placed into the die before injection into said die. Materials known in the prior art for this application, in particular carbon fibers, can be used as the fibers and/or semi-finished fiber products.

In various embodiments, resin compositions of this kind are adhesive compositions or injection resins. The injection resins are preferably pumpable and in particular suitable for transfer molding (RTM method). In various embodiments, the reaction mixture therefore has a viscosity of <100 mPas at a temperature of 100° C., i.e., a typical infusion temperature.

In one embodiment, the invention therefore also relates to the molded parts which can be obtained in the RTM method by means of the resin systems according to the invention. RTM methods in which the described resin systems can be used are known per se in the prior art and can be readily adapted by a person skilled in the art such that the reaction mixture according to the invention can be used.

The open times of the resin compositions, as described herein, are preferably greater than 90 seconds and are preferably in the range of from 2 to 5 minutes, in particular are approximately 3 minutes. “Approximately,” as used herein in relation to a numerical value, means the numerical value ±10%.

Depending on the type of epoxides and curing agents used and the use of the cured composition, the resin composition in step (2) of the method according to the invention can be cured at different reaction temperatures. The curing temperature can thus be between 70° C. and 280° C.

The curing process can generally be carried out at an elevated temperature, i.e., >25° C. The resins are preferably cured between 80° C. and 280° C. and more preferably between 100° C. and 240° C. The duration of the curing process likewise depends on the resins to be cured and on the catalyst composition and can be between 0.01 hours and 10 hours. The curing cycle preferably lasts a few minutes, i.e., in particular 1 to 15 minutes. The curing process can also take place in one or more steps.

In some embodiments, the resin composition described herein is cured in a one-step method at a temperature of between 80° C. and 240° C., preferably between 100° C. and 200° C., and more preferably between 120° C. and 180° C., for 0.01 hours to 10 hours, preferably for 0.1 hour to 5 hours, more preferably for 1 hour.

In alternative embodiments, a resin composition as described herein can be cured in a multi-step method. Such a multi-step method includes a first step of pre-curing, the resin composition being pre-cured at a temperature of between 70° C. and 150° C., preferably 100° C. and 140° C., and more preferably at 120° C., for 0.1 hours to 3 hours, preferably for 0.5 hours to 2 hours, more preferably for 1 hour, and is then post-cured in a second step. This second step of post-curing can comprise one or more sub-steps such that the pre-cured resin composition is post-cured at least once, preferably at least twice, and more preferably at least three times, in each case at a temperature of between 110° C. and 260° C., preferably 130° C. and 190° C., and more preferably at 180° C., in each case for 0.1 hours to 3 hours, preferably for 0.5 hours to 2 hours, and more preferably for 1 hour. For example, such a second curing step can comprise post-curing the pre-cured resin composition at a temperature of between 130° C. and 230° C., preferably 150° C. and 220° C., and more preferably at 180° C., for 0.1 hours to 3 hours, preferably for 0.5 hours to 2 hours, and more preferably for 1 hour; then at a temperature of between 150° C. and 250° C., preferably between 170° C. and 230° C., and more preferably at 190° C., for 0.1 hours to 3 hours, preferably for 0.5 hours to 2 hours, and more preferably for 1 hour; and then at a temperature of between 180° C. and 260° C., preferably 200° C. and 250° C., and more preferably at 220° C., for 0.1 hours to 3 hours, preferably for 0.5 hours to 2 hours, and more preferably for 1 hour.

The resins cured as described herein preferably have a critical stress intensity factor K1c of ≥0.9, preferably ≥1.0, more preferably ≥1.2, and most preferably ≥1.3. In various embodiments, the glass transition temperature of the cured resins is in the range of ≥200° C., in particular ≥210° C., and typically in the range of up to 230° C. The modulus of elasticity of the cured resins is preferably at least 2,000 N/mm², more preferably at least 2,100 N/mm², and typically in the range of from 2,200 to 5,000 N/mm².

Moreover, the present invention relates to the cured composition which can be obtained according to the method described herein. Depending on the method, said composition can be present as a molded part, in particular as a fiber-reinforced plastics molded part. Such molded parts are preferably used in automobile construction or aerospace.

The cured compositions are thus particularly suitable as a matrix resin for fiber composite materials. These can be used in various methods of application, for example in the resin transfer molding method (RTM method) or in the infusion method.

Known high-performance fiber materials are suitable as fiber constituents of the fiber composite materials. These can consist, for example, of glass fibers; synthetic fibers such as polyester fibers, polyethylene fibers, polypropylene fibers, polyamide fibers, polyimide fibers or aramid fibers; carbon fibers; boron fibers; oxide or non-oxide ceramic fibers such as aluminum oxide/silicon dioxide fibers, silicon carbide fibers; metal fibers, for example made of steel or aluminum; or of natural fibers such as flax, hemp or jute. Said fibers can be incorporated in the form of mats, woven fabrics, knitted fabrics, non-woven fabrics, fibrous webs or rovings. Two or more of these fiber materials may also be used as a mixture. Short cut fibers can be selected, but preferably synthetic long fibers are used, in particular woven and non-woven fabrics. Such high strength fibers, non-woven fabrics, woven fabrics and rovings are known to a person skilled in the art.

In particular, the fiber composite material should contain fibers in a proportion by volume of more than 40 vol. %, preferably more than 50 vol. %, particularly preferably between 50 and 70 vol. %, based on the total fiber composite material, in order to achieve particularly good mechanical properties. In the case of carbon fibers, the proportion by volume is determined according to standard DIN EN 2564:1998-08 and in the case of glass fibers, it is determined according to standard DIN EN ISO 1172:1998-12.

A fiber composite material of this kind is suitable in particular as an automobile part. Compared with steel, such fiber composite components have several advantages, i.e., they are lighter in weight, are characterized by improved crash resistance and are also more durable.

Moreover, it goes without saying that all embodiments that have been disclosed above in connection with the method according to the invention can also be applied in the same manner in the described resin systems and cured compositions, and vice versa.

### EXAMPLES

### Comparative Example

Epoxy Resin Component:

143.1 g cycloaliphatic epoxy with 30% core-shell structure particles

3.2 g multi-functional fatty acid ester (release agent)

Curing Component:

131.1 g mixture of hexahydrophthalic anhydride and methylhexahydrophthalic anhydride

2.0 g 1-methylimidazole

The epoxy resin component and the curing component were homogenized and then poured into a steel mold. The pre-curing took place at 120° C. over a period of 30 minutes. The mixture was then kept at 180° C. for one hour in order to ensure complete cross-linking. In this way, polymer plates approximately 4 mm thick with an area of 20 cm×20 cm were produced.

The physical properties of the plate produced in this way are clearly summarized in the table below.

TABLE 1
Physical properties of the comparative example formulation

| | |
|---|---|
| Flexural modulus [MPa] | 2,011 |
| Flexural strength [MPa] | 98 |
| K1c [MPa*m½] | 1.4 |
| Tg DMA tan delta [° C.] | 226 |
| Tg DMA E′ onset [° C.] | 177 |
| Transparency* | 5 |
| Yellowing** | 5 |

*= fully transparent; 10 = non-transparent
**= clear, no yellowing; 10 = dark yellow

### Example Formulation 1

Epoxy Resin Component:

180.0 g cycloaliphatic epoxy with 30% core-shell structure particles 3.4 g multi-functional fatty acid ester (release agent)

Curing Component:

162.9 g mixture of hexahydrophthalic anhydride and methylhexahydrophthalic anhydride

2.3 g trihexyl(tetradecyl)phosphonium chloride

The epoxy resin component and the curing component were homogenized and then poured into a steel mold. The pre-curing took place at 120° C. over a period of 30 minutes. The mixture was then kept at 180° C. for one hour in order to ensure complete cross-linking. In this way, polymer plates approximately 4 mm thick with an area of 20 cm×20 cm were produced.

The physical properties of the plate produced in this way are clearly summarized in the table below.

TABLE 2
Physical properties of example formulation 1

| | |
|---|---|
| Flexural modulus [MPa] | 2,059 |
| Flexural strength [MPa] | 94.0 |
| K1c [MPa*m½] | 1.4 |
| Tg DMA tan delta [° C.] | 217 |
| Tg DMA E′ onset [° C.] | 188 |
| Transparency* | 1-2 |
| Yellowing** | 3 |

*= fully transparent; 10 = non-transparent
**= clear, no yellowing; 10 = dark yellow

### Example Formulation 2

Epoxy Resin Component:

142.0 g cycloaliphatic epoxy with 30% core-shell structure particles

3.3 g multi-functional fatty acid ester (release agent)

Curing Component:

137.0 g methylhexahydrophthalic anhydride

1.9 g trihexyl(tetradecyl)phosphonium chloride

The epoxy resin component and the curing component were homogenized and then poured into a steel mold. The pre-curing took place at 120° C. over a period of 30 minutes. The mixture was then kept at 180° C. for one hour in order to ensure complete cross-linking. In this way, polymer plates approximately 4 mm thick with an area of 20 cm×20 cm were produced.

The physical properties of the plate produced in this way are clearly summarized in the table below.

TABLE 3
Physical properties of example formulation 2

| | |
|---|---|
| Flexural modulus [MPa] | 1,982 |
| Flexural strength [MPa] | 83 |
| K1c [MPa*m½] | 1.4 |
| Tg DMA tan delta [° C.] | 223 |
| Tg DMA E′ onset [° C.] | 182 |
| Transparency* | 1 |
| Yellowing** | 1-2 |

*= fully transparent; 10 = non-transparent
**= clear, no yellowing; 10 = dark yellow

The direct comparison of the two example formulations 1 and 2 according to the present invention with the formulation of the comparative example shows that the use of a quaternary phosphonium compound instead of an amine catalyst in cycloaliphatic epoxy resin compositions results in cured items which are more transparent and more colorless (i.e., less yellowed). In addition, the cured items have an increased E′ onset glass transition temperature.

What is claimed is:

1. A resin composition comprising at least one epoxy resin component at least one curing component and at least one quaternary phosphonium compound.

2. The resin composition according to claim 1, characterized in that the amount of the at least one quaternary phosphonium compound is in the range of from 0.1 to 5 wt. %, based on the total weight of the resin composition.

3. The resin composition according to claim 1, characterized in that the resin composition is substantially free from tertiary amine compounds.

4. The resin composition according to claim 1, characterized in that the at least one quaternary phosphonium compound is trihexyl(tetradecyl)phosphonium chloride.

5. The resin composition according to claim 1, characterized in that the at least one epoxy resin component is an epoxy compound selected from the group consisting of bis-(3,4-epoxycyclohexylmethyl) oxalate, bis-(3,4-epoxycyclohexylmethyl) adipate, bis-(3,4-epoxy-6-methylcyclohexylmethyl) adipate, bis-(3,4-epoxycyclohexylmethyl) pimelate, 3,4-epoxycyclohexylmethyl-3,4-epoxycyclohexane carboxylate, bis-(3,4-epoxycyclohexyl) adipate, 3,4-epoxy-1-methylcyclohexylmethyl-3,4-epoxy-1-methylcyclohexane carboxylate, and mixtures thereof.

6. The resin composition according to claim 1, characterized in that the at least one curing component comprises at least one anhydride curing agent.

7. The resin composition according to claim 6, characterized in that the at least one anhydride curing agent is selected from bicyclo[2.2.1]-5-heptene-2,3-dicarboxylic acid anhydride, bicyclo[2.2.1]methylhept-5-ene-2,3-dicarboxylic acid anhydride, and mixtures thereof.

8. A method for producing a cured composition comprising the steps of:
(1) viding a resin composition according to claim 1; and
(2) curing the resin composition in order to obtain a cured composition.

9. The method according to claim 8, characterized in that the method is a transfer molding (RTM) method and the resin composition is a reactive injection resin.

10. The method according to claim 8, characterized in that step (1) comprises injecting the resin composition into a die in which fibers or semi-finished fiber products (prewovens/preforms) are placed.

11. The method according to claim 8, characterized in that
(a) the resin composition in step (2) is cured at a temperature of between 80° C. and 240° C., for 0.01 to 10 hours; or
(b) the resin composition in step (2) is first pre-cured at a temperature of between 70° C. and 150° C., for 0.1 to 3 hours, and is then post-cured at least once in each case at a temperature of between 110° C. and 260° C., in each case for 0.1 to 3 hours.

12. A cured composition obtainable according to a method to claim 8.

13. The cured composition according to claim 12, characterized in that the K1c value of the cured composition is at least 0.9.

14. The cured composition according to claim 12, characterized in that the cured composition has a glass transition temperature T_{g} 200° C.

15. The cured composition according to claim 12, characterized in that the cured composition is a molded part, in particular a fiber-reinforced molded part.
